(19) United States
(12) Patent Application Publication
(10) Pub. No.: US 2018/0111231 A1
(43) Pub. Date: Apr. 26, 2018

(54) METHOD FOR METALLURGICALLY BONDING A CYLINDER LINER INTO A BORE IN AN ENGINE BLOCK

(71) Applicant: GM GLOBAL TECHNOLOGY OPERATIONS LLC, DETROIT, MI (US)

(72) Inventors: Qigui Wang, Rochester Hills, MI (US); William L. Miller, Birmingham, MI (US); Jianghuai Yang, Rochester Hills, MI (US); Huaxin Li, Rochester Hills, MI (US)

(21) Appl. No.: 15/333,219

(22) Filed: Oct. 25, 2016

(51) Int. Cl. B23K 31/02; F02F 1/00; B23K 37/053

(52) U.S. Cl. CPC B23K 31/02; F02F 1/004; B23K 2201/006; F02F 2200/00; B23K 37/053

(57) ABSTRACT

A method for metallurgically bonding a cylinder liner in a bore in an engine block includes axially aligning the cylinder liner with a bore in the engine block, rotating the cylinder liner about the aligned axis, and translating the cylinder liner along the aligned axis to position the cylinder liner within the bore.

### FIELD

The present disclosure relates to a method for metallurgically bonding a cylinder liner into a bore in an engine block.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

During a combustion cycle of an internal combustion engine (ICE), air/fuel mixtures are provided to cylinders within an engine block of the ICE. The air/fuel mixtures are compressed and/or ignited and combusted to provide output torque via pistons positioned within the cylinders. As the pistons move within the cylinders, friction between the piston and cylinder and the presence of fuel can wear and degrade the cylinder surfaces. Additionally, combustion pressure and piston side loading can pose significant amount of stresses on the cylinder bores.

Historically, ICES have employed cylinder liners to prevent wear or damage to the engine block. Cylinder liners have been made of various grades of cast iron (e.g., gray iron). Cast iron is selected in part for its low production cost, easy manufacture, satisfactory thermal conductivity which minimizes bore distortion, and good wear resistance due to the presence of free graphite which acts as a lubricant and reduces friction with the piston ring pack. Unfortunately, gray iron materials impart significant undesired weight to an engine block, due to their high densities (e.g., >7.1 g/cm³) and high wall thicknesses (e.g., about 2 to 4 mm) needed to compensate for poor mechanical properites (e.g., low strength and low modulus of elasticity). High wall thicknesses increase the weight of the engine and can reduce overall ICE system efficiency, for example where the engine is a diesel or gasoline engine and powers a vehicle. Further, gray iron cylinder liners are susceptible to cracking during manufacturing or service, in part due to the residual stress inherited from the casting process.

Thermal spray steel cylinder bores have been identified as an alternative to gray iron cylinder liners, particularly due to the weight saving advantages provided by the very thin wall thicknesses (e.g., 100-300 μm). However, manufacturing thermal spray bores is complex and requires expensive materials and equipment, yet the performance characteristics are only marginally enhanced, if at all. For example, improvements in wear resistance and friction reduction are minimal relative to gray iron cylinder liners. Further, the high thermal conductivity of thermal spray bores increases thermal management complexity due to high heat loss between the coating layer and cylinder bore, and the susceptibility to cylinder bore distortion can induce unexpected blow-by and oil consumption.

Cylinder liners may be installed into an engine block by several processes. One example is a press-in-place method where the temperature of the cylinder liner is reduced and/or the temperature of the engine block is increased. This cooling and/or heating reduces and/or eliminates any interference between the outer diameter of the cylinder liner and the inner diameter of the cylinder in the engine block. The cylinder liner may then be easily placed within the block and, as the temperatures between the cylinder liner and the engine block equalize, the interference is increased which firmly fixes the cylinder liner in place.

Another known process for installing a cylinder liner is known as a cast-in-place process. In this process, the cylinder liner is placed within a mold or die into which molten metal is introduced to form an engine block around the cylinder liner. For example, a cast iron cylinder liner may be placed in a mold or die and molten aluminum is then introduced into the die or mold. The molten aluminum surrounds the outer surface of the cylinder liner and solidifies as it cools. Typically, the external surface of the cylinder liner may have a roughened or “spiny” surface (including, for example, projections which are formed during the liner casting process) which provides a mechanical lock between the solidified aluminum engine block and the cast iron cylinder liner.

These processes result in residual stresses from the thermal reactions due to the differences in thermal coefficients between the cylinder liner and engine block. Further, both processes may involve thermal shock being applied to the cylinder liner, the block or both. These residual stresses and shocks may result in structural failure, such as, for example, cracks developing in the liner, the block, or both.

Additionally, the bond between the block and the liner are particularly weak, especially in the case of the cast-in-place process. Further, during operation as temperatures increase, gaps may form and/or grow between the liner and block.

### SUMMARY

In an exemplary aspect, a method for metallurgically bonding a cylinder liner in a bore in an engine block includes axially aligning the cylinder liner with a bore in the engine block, rotating the cylinder liner about the aligned axis, and translating the cylinder liner along the aligned axis to position the cylinder liner within the bore.

In another exemplary aspect, the method further includes pre-heating the engine block prior to translating the cylinder liner.

In another exemplary aspect, the method includes pre-heating the engine block to a temperature below the solidus temperature of the engine block.

In another exemplary aspect, the method includes pre-heating the engine block bore surface.

In another exemplary aspect, the method includes applying a coating to an outer surface of the cylinder liner prior to translating the cylinder liner.

In another exemplary aspect, the coating includes a material having a lower melting point than the engine block.

In another exemplary aspect, the method includes applying a coating to an inner surface of the bore prior to translating the cylinder liner.

In another exemplary aspect, the coating includes a material having a lower melting point than the engine block.

In another exemplary aspect, the cylinder liner has a draft angle on an outer surface.

In another exemplary aspect, the inner surface of the bore has a draft angle.

In another exemplary aspect, the method further includes applying a pattern having a predetermined surface roughness to an outer surface of the cylinder liner.

In another exemplary aspect, the method further includes applying a pattern having a predetermined surface roughness to an inner surface of the bore.

In another exemplary aspect, the method further includes applying a texture having a predetermined surface roughness to an outer surface of the cylinder liner.

In another exemplary aspect, the method further includes applying a texture having a predetermined surface roughness to an inner surface of the bore.

In another exemplary aspect, the cylinder liner includes a steel alloy.

In another exemplary aspect, the cylinder liner includes a stainless steel alloy.

In another exemplary aspect, the cylinder liner includes an iron alloy.

In another exemplary aspect, the engine block includes an aluminum alloy.

In another exemplary aspect, the engine block includes a magnesium alloy.

In this manner, residual stresses are reduced or eliminated, improved thermal transfer characteristics between the liner and the block is provided, a metallurgical bond free of voids and discontinuities is provided, a liner having improved ductility, higher strength and toughness can be more easily provided in an engine block, the cost of materials can be reduced, larger internal combustion bores and resultant higher power densities are achievable, bore distortion is reduced, thermal stability is improved, oil consumption is reduced, blow-by is reduced, friction is reduced and/or better managed, resistance to thermal shock is improved, weight is reduced, and packaging is improved. Further, the metallurgical bond produces an interfacial strength between the block and the liner, improves block strength and stiffness and improves engine durability and performance.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a cross-sectional side view of a piston and cylinder bore;

FIG. 2A is a cross-sectional side view of an exemplary cylinder liner installation method in accordance with the invention;

FIG. 2B is another cross-sectional side view of the exemplary cylinder liner installation method of FIG. 2A;

FIG. 3A is a cross-sectional side view of another exemplary cylinder liner installation method in accordance with the invention; and

FIG. 3B is another cross-sectional side view of the exemplary cylinder liner installation method of FIG. 3A.

### DETAILED DESCRIPTION

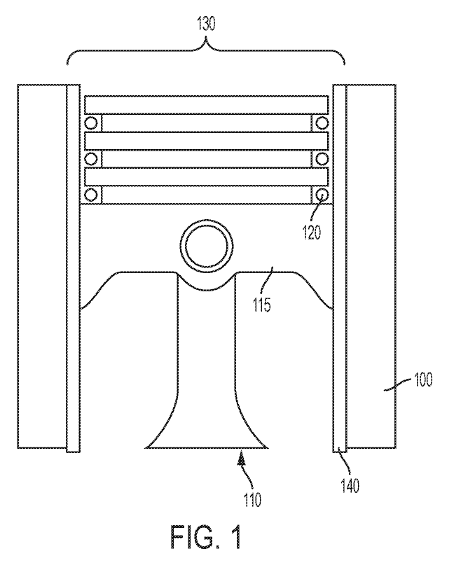

Referring to FIG. 1, a piston 110 is positioned within an engine block 100 cylinder bore 130. Piston 110 includes a head 115 with one or more piston rings 120. Cylinder liner 140 is installed within the cylinder bore 130. During a combustion cycle of an internal combustion engine (ICE), air/fuel mixtures are provided to cylinders (e.g., cylinder 130) of the ICE. The air/fuel mixtures are compressed and/or ignited and combusted to provide output torque via pistons (e.g., piston 110) positioned within the cylinders. Cylinder liner 140 can come in contact with one or more rings 120 and/or piston 110, during operation of an ICE. Cylinder liner 140 can serve to prevent wear or degradation of the engine block 100 from contact with the piston 110 and/or one or more of fuel and combustion gases. Cylinder liner 140 outer, engine block-side contour can substantially conform to the inner contour of the cylinder 130.

In an exemplary embodiment the cylinder liner 140 may include a steel alloy. For example, the cylinder liner may include steel alloys disclosed within U.S. patent application Ser. No. 15/251,259, filed on Aug. 30, 2016, and which is incorporated herein by reference in its entirety. Steel alloys, such as that disclosed by the incorporated reference, possess advantages over conventional cylinder liners, such as gray iron liners or advanced thermal sprayed steel liners, due to increased strength and stiffness (e.g., tensile strength and Young's modulus), high compatibility with piston ring packages, and lower wear rate, physical distortion, and friction with pistons. In particular, the high strength and stiffness of the disclosed steel alloys provides thinner, lighter cylinder liners relative to the conventional materials.

Further, a steel cylinder liner 140 can reduce manufacturing cost and/or complexity associated with conventional cylinder liner manufacturing. Cylinder liner 140 can be manufactured using mature technology, such as hot finished seamless (HFS) which manufactures the cylinder liner 140 to a desired outer diameter and wall thickness, hot extrusion, or draw over mandrel (DOM) for electric resistance seam welding. Cylinder liner 140 can accordingly be manufactured to a near-net shape with minimal machining stock. Cylinder liner 140 can air-cool and self-harden. Cylinder liner 140 can be shot blasted on the outer wall and/or ends prior to descaling and installation in engine block 100. Cylinder liner 140 can be lightly machined on the inner wall prior to applying a mirror-like finish.

Although the present invention is not limited to use with steel cylinder liners, the inventors have discovered many advantages are obtained through use of a steel cylinder liner over an iron liner. The higher strength of steel enables a thinner wall cylinder liner, which reduces the mass of the cylinder liner, enables an overall smaller package size, enables a larger bore, reduces mass, as well as providing multiple other significant advantages.

Further, steel cylinder liners may reduce the amount of bore distortion experienced during operation of the engine. Thermal stability of a steel liner is higher which results in less distortion which means less oil consumption, less blow-by, less friction, better and more intimate contact with the piston rings. The improved stability of a steel cylinder liner makes management of the interference and contact between surfaces to be better managed.

Additionally, the higher ductility and toughness of a steel liner provides increased resistance to cracking and thermal shock. A steel cylinder liner has the ability to better absorb the energy of applied stresses by elastically straining and returning to a better controlled shape.

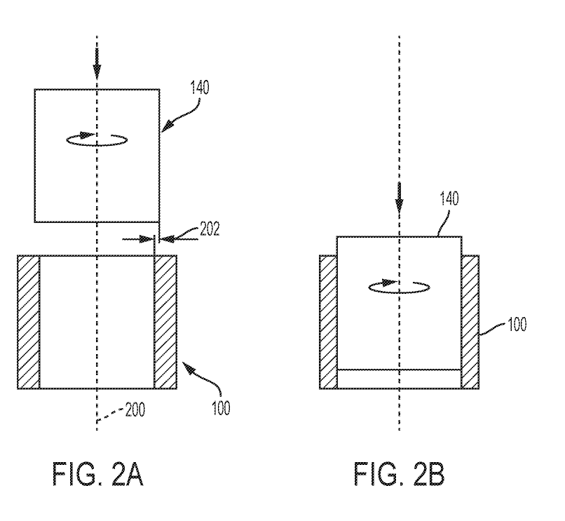

FIGS. 2A and 2B illustrate an exemplary method for installing a cylinder liner into an engine block 100 in accordance with the present invention. The cylinder liner 140 may be aligned with a common axis 200 between the cylinder liner 140 and the bore in the engine block 100. The cylinder liner 140 may then be spun or rotated about the common, aligned axis 200 as illustrated in FIG. 2A. The cylinder liner 140 may then be translated along the common, aligned axis 200 into a position within the bore of the engine block 100 as is illustrated in FIG. 2B.

There may be a slight interference fit 202 between the outer surface of the cylinder liner 140 and the inner surface of the bore in the engine block 100 such that, as the cylinder liner is spun and translated, the relative motion and contact between those surfaces results in friction generating heat which causes the engine block to locally soften, plasticize, or melt slightly. Preferably, the heat generated by this friction results in the engine block 100 material achieving a temperature locally that exceeds the solidus temperature. This local softening or melting may also reduce the friction between the surfaces which reduces the forces required to continue rotating and translating the cylinder liner 140 into the bore of the engine block 100.

Further, the sliding contact between the cylinder liner 140 and the inner surface of the bore in the engine block 100 will mechanically remove oxide films from the bore surface (such as an aluminum oxide from an aluminum alloy block). Thus, the spinning contact exposes fresh surfaces clear of oxides on the bore surface to come into direct contact with the outer surface of the cylinder liner 140.

The friction may alternatively generate sufficient heat to raise the temperature of the inner surface of the bore to just under the solidus temperature but high enough such that atomic diffusion between the bore surface and the cylinder liner occurs. This further encourages establishing a metallurgical bond between the two surfaces.

Once the desired position along the common, aligned axis is achieved by the cylinder liner 140 into the bore of the engine block 100, the rotation may be stopped. The engine block 100 material will then cool and solidify again into intimate contact with the outer surface of the cylinder liner 140 resulting in a metallurgical bond between the outer surface of the cylinder liner 140 and the inner surface of the bore of the engine block 100.

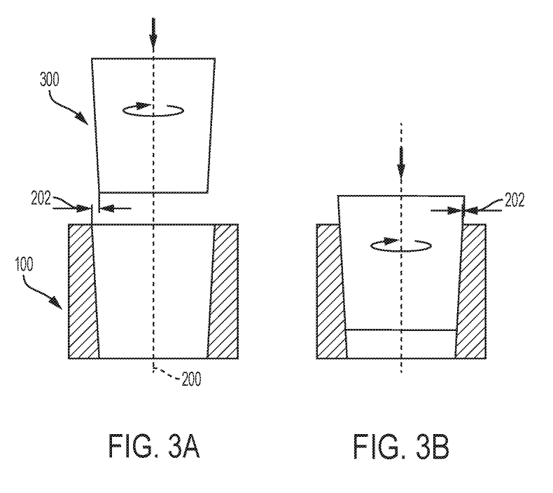

FIGS. 3A and 3B illustrate another exemplary method for installing a cylinder liner 140 into an engine block 100. The method illustrated in FIGS. 3A and 3B are the same as is described above with reference to FIGS. 2A and 2B with the exception that the outer surface of the cylinder liner 140 and the inner surface of the bore of the engine block 100 are both inclined, tapered, or otherwise provided with a draft angle 300. The draft angle 300 may encourage simultaneous initial contact between the surfaces which may result in consistent temperatures across the entire contact surfaces. In contrast, a low or no draft angle may result in a wide variance in temperatures across in the axial direction across the contact surfaces. On the other hand, simultaneous initial contact may result in sudden initial contact torques that may be difficult to control. In contrast, a low or no draft angle may result in a gradual increase in torque throughout the process which may be easier to control. The draft angle preferably may be about 0.1 degree, and preferably no more than 0.5 or one degree.

In an exemplary aspect, a coating may be applied to the outer surface of the cylinder liner, the inner surface of the bore, or both. The material for the coating may be different than that of the cylinder liner and/or the engine block and may serve as a lubricant and/or be a material that encourages metallurgical bonding between the coating, the outer surface of the cylinder liner, the inner surface of the bore, and/or both. For example, the coating may reduce the amount of heat required to be generated and/or reduce the temperature at which a metallurgical bond may be achieved. Further, the coating may serve as a bridge between the outer surface of the cylinder liner and the inner surface of the bore of the engine block by providing a metallurgical bond between at least one of the coating, the outer surface of the cylinder liner, and the inner surface of the bore of the engine block. A lubricating effect provided by such a coating may also make it easier to control the amount of heat generated by the friction and transferred into the engine block. Moreover, atomic diffusion between the coating and the liner and/or block may also occur which may further assist in establishing a metallurgical bond.

In another exemplary aspect, the engine block, cylinder liner, and/or both may be pre-heated prior to rotating and translating the cylinder liner into the engine block. In this manner, the amount of heat that may be required to be generated by the friction between the moving surfaces may be reduced. Preferably, the engine block bore is locally pre-heated to a temperature close to but below the solidus temperature of the engine block material. A temperature that is higher than the solidus temperature may damage the engine block due to, for example, incipient melting.

In another exemplary aspect, the outer surface of the cylinder liner, the inner surface of the bore of the engine block, and/or both may be provided with a patterned surface having a predetermined roughness. In a preferred embodiment, the surface roughness may be about 40 micrometers. One exemplary pattern may include a threaded surface. A patterned surface may provide the additional benefit of not only providing a metallurgical bond but also a mechanical bond between the surfaces.

Now having knowledge of the present invention, those of ordinary skill in the art will understand that several factors will affect the quality of the metallurgical bonding process. For example, the rotational speed of the cylinder liner, the translational speed, the amount of interference, the pressure applied to the rotating liner during the translational process may all affect the quality of the metallurgical bond achieved using the inventive process.

In this manner, residual stresses are reduced or eliminated, improved thermal transfer characteristics between the liner and the block is provided, a metallurgical bond free of voids and discontinuities is provided, a liner having improved ductility, higher strength and toughness can be more easily provided in an engine block, the cost of materials can be reduced, larger internal combustion bores and resultant higher power densities are achievable, bore distortion is reduced, thermal stability is improved, oil consumption is reduced, blow-by is reduced, friction is reduce and/or better managed, resistance to thermal shock is improved, weight is reduced, and packaging is improved.

In an exemplary embodiment, the engine block is made of an aluminum alloy. This is preferable for the inventive metallurgical bonding process because aluminum alloys tend to have a wide temperature range between the solidus and liquidus points. This provides flexibility and confidence that the heat generated by the friction during the inventive process will not likely result in temperatures exceeding the liquidus temperature beyond those portions immediately adjacent to the rotating and translating cylinder liner.

In contrast to the conventional methods for installing a cylinder liner in an engine block which almost always resulted in clear boundary and gaps between the materials, the inventive process results in a metallurgical bond which provides a very intimate, almost indistinguishable boundary between the cylinder liner and engine block. This improves the ability to transfer heat from the cylinder liner and engine block which results in better heat management. Additionally, the metallurgical bond is further reinforced during engine service because the heat of combustion further encourages atomic diffusion between the liner and the block. Thereby, further strengthening the metallurgical bond provided by the inventive method.

The term metallurgical bonding is intended to mean any bond which results in an intimate contact between surfaces such that the boundary between the materials is not specifically identifiable. Rather, there is a gradual transition between the materials. For example, any process which forms an intermetallic compound between the liner and bore may also qualify as a metallurgical bond. A friction weld process is one exemplary process that may result in a metallurgical bond in accordance with the present invention. A metallurgical bond may also result in a single phase between two lattice structures of the joined materials. Exemplary methods for achieving a metallurgical bond in accordance with the present invention may include low melting point material diffusing into the adjoining material (for example, an aluminum material in an engine block may diffuse into the steel material of a cylinder liner); and the materials may form a new compound material, without limitation. The metallurgical bonding may be achieved a lower temperatures not resulting in material melting or higher temperatures that produce material melting, without limitation.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for metallurgically bonding a cylinder liner in a bore in an engine block, the method comprising:
axially aligning the cylinder liner with a bore in the engine block;
rotating the cylinder liner about the aligned axis; and
translating the cylinder liner along the aligned axis to position the cylinder liner within the bore.

2. The method of claim 1, further comprising pre-heating the engine block prior to translating the cylinder liner.

3. The method of claim 2, wherein pre-heating the engine block comprises pre-heating the engine block to a temperature below the solidus temperature of the engine block material.

4. The method of claim 1, wherein pre-heating the engine block comprises pre-heating the engine block bore surface.

5. The method of claim 1, further comprising applying a coating to an outer surface of the cylinder liner prior to translating the cylinder liner.

6. The method of claim 5, wherein the coating comprises a material having a lower melting point than the engine block material.

7. The method of claim 1, further comprising applying a coating to an inner surface of the bore prior to translating the cylinder liner.

8. The method of claim 7, wherein the coating comprises a material having a lower melting point than the engine block material.

9. The method of claim 1, wherein the cylinder liner has a draft angle on an outer surface.

10. The method of claim 1, wherein an inner surface of the bore has a draft angle.

11. The method of claim 1, further comprising applying a pattern having a predetermined surface roughness to an outer surface of the cylinder liner.

12. The method of claim 1, further comprising applying a pattern having a predetermined surface roughness to an inner surface of the bore.

13. The method of claim 1, further comprising applying a texture having a predetermined surface roughness to an outer surface of the cylinder liner.

14. The method of claim 1, further comprising applying a texture having a predetermined surface roughness to an inner surface of the bore.

15. The method of claim 1, wherein the cylinder liner comprises a steel alloy.

16. The method of claim 15, wherein the steel alloy comprises a stainless steel alloy.

17. The method of claim 1, wherein the cylinder liner comprises an iron alloy.

18. The method of claim 1, wherein the engine block comprises an aluminum alloy.

19. The method of claim 1, wherein the engine block comprises a magnesium alloy.
